(19) United States
(12) Patent Application Publication
(10) Pub. No.: US 2012/0183747 A1
(43) Pub. Date: Jul. 19, 2012

(54) Useful aramid blends

(75) Inventors: Yves Bader, Crozet (FR); Andre Capt, Gland (CH)

(73) Assignee: E.I. DU PONT DE NEMOURS AND COMPANY, Wilmington, DE (US)

(21) Appl. No.: 12/939,458

(22) Filed: Nov. 4, 2010

Related U.S. Application Data
(60) Provisional application No. 61/258,292, filed on Nov. 5, 2009.

(51) Int. Cl. B32B 3/00; D03D 15/00; D03D 15/12

(52) U.S. Cl. 428/195.1; 442/302; 442/200

(57) ABSTRACT

The present invention relates to a fabric comprising a warp system and a weft system. The warp system comprises at least one flame retardant yarn comprising aramid fibers and the weft system comprises at least one core spun yarn. The flame retardant yarn of the warp system is covered by at least 70% of the weft system.

The fabric according to the present invention has an ink receptive surface and a thermal protection surface, and has particularly excellent mechanical, flame resistance and printability properties due to the structure of its weft and warp systems and the materials used and is particularly useful in confection of combat uniforms. Furthermore, the fabric according to the present invention is also exceptionally abrasion resistant, which prevents the fading of a printed image thereon.

### FIELD OF THE INVENTION

The present invention relates to the field of textile applications, particularly to the field of flame retardant textile applications.

### BACKGROUND OF THE INVENTION

Nowadays, many functional garments used in the military are available that protect the wearer against the potential threats of a combat theater, such as ballistic, chemical or thermal threats. However, the use of these garments in military applications imparts further requirements in addition to the dedicated protection they offer. For example, the colors and camouflage patterns of a military combat uniform are made to both identify and camouflage its wearer in the field, and are an essential feature of the combat uniform.

Combat uniform fabrics are usually woven from yarns made from a staple blend of cotton, polyester and/or nylon fiber. This fiber selection primarily supports dyeing and printing using a combination of acid and vat dyes to impart a camouflage pattern providing both visual and near infrared camouflage protection. This cotton and/or nylon polyester fiber blend yarn, in combination with a lightweight, thin fabric construction, has consistently provided protection, comfort, durability, and UV resistance for military service personnel for more than twenty years. Traditionally, military combat uniforms, especially infantry uniforms, did not have to offer protection against incendiary and/or thermal threats. However, in recent years, peacekeeping forces had to face an increasing amount of threats that rely on the action of fire, such as incendiary devices, petrol bombs and/or improvised explosive devices (IEDs).

It is nowadays possible to manufacture garments out of flame retardant fibers such as aramid fibers, which provide excellent protection against fire threats, while at the same time being light and comfortable to wear. Examples of such protective garments can be found, among others, in U.S. Pat. No. 7,402,538, US-A 20060035553 or EP-A 1796492. However, a known problem with the aramid fibers is that they do not accept ink or pigment in a satisfactory manner. The ink or pigment remains at the outer surface of the fiber and can be subsequently abraded during wear, wash cycles and/or friction. The abrasion of the ink or pigment then reveals the bare aramid fiber which is bright white. Some dyes, like cationic dyes, offer good abrasion resistance properties, but suffer from very poor light fastness.

Although these problems do not impact the above mentioned protective effect against flames, this abrasion and/or fading significantly decreases the effectiveness of the camouflage by giving it a whitish tint. The whitish tint results in increased visibility of the wearer, thereby augmenting the probability of being him being detected and engaged. Thus, there is strong desire to provide a garment that is flame retardant, but at the same time is also easily printable and maintains the visual aspect of a uniform intact, even in harsh conditions, such as to warrant effective camouflage.

### SUMMARY OF THE INVENTION

The present invention relates to a fabric comprising a warp system and a weft system. The warp system comprises at least one flame retardant yarn comprising aramid fibers, that means meta-aramid fibers, para-aramid fibers and/or combinations thereof, and the weft system comprises at least one core spun yarn. The flame retardant yarn of the warp system is covered by at least 70% of the weft system, that means of the core spun yarn of the weft system.

The fabric according to the present invention has an ink receptive surface and a thermal protection surface, and has particularly excellent mechanical, flame resistance and printability properties due to the structure of its weft and warp systems and the materials used and is particularly useful in confection of combat uniforms. Furthermore, the fabric according to the present invention is also exceptionally abrasion resistant, which prevents the fading of a printed image thereon.

### DETAILED DESCRIPTION

The fabric according to the present invention is a fabric comprising a warp system and a weft system. The fabric offers particularly excellent mechanical, flame resistance and printability properties due to the structure of its weft and warp systems and the materials used therein, and is particularly useful for weaves used in confection of functional garments.

The weft system of the invention comprises at least one core spun yarn having a core and a sheath wherein the core is made of at least one mechanically resistant fiber material and the sheath comprises at least one non-thermoplastic fiber material. By “mechanically resistant fiber material” it is meant a fiber having a tenacity of greater than 23 cN/tex. According to a particular weave of the fabric according to the invention, the fabric side facing away from the wearer, and that forms the exterior surface of a garment containing the fabric, comprises core spun yarns that confer good printability, thermal protection, abrasion and mechanical resistance to the fabric.

The weft system comprises at least one core spun yarn wherein the core comprises fibers made from poly(phenylene sulfide sulfone), aramid, acrylic, elastane, polypropylene, polyethylene, polyester and/or combinations thereof. More preferably, the core comprises polyester fibers and/or elastane fibers.

The core can be in the form of monofilaments, multiple filaments, spun yarns and/or composites thereof. Preferably, the core is made from a synthetic polymer and is in the form of multiple filaments.

The weft system comprises a core spun yarn wherein the sheath comprises at least one non-thermoplastic fiber material. Preferred non-thermoplastic fiber materials include natural materials and materials derived therefrom that do not melt and are readily dyeable to deep shades.

The sheath of the core spun yarn may additionally comprise at least one thermoplastic fiber material. If the sheath of the core spun yarn contains such additional thermoplastic fiber material the amount of the additional thermoplastic fiber material in the core spun yarn can be in such a range that the amount of the non-thermoplastic fiber material is at least 1.5 times more, preferably 1.5 to 10 times more, than the amount of the thermoplastic fiber material of the core spun yarn.

The non-thermoplastic fiber material can be chosen among cellulose, viscose, modified cellulose, modacrylic, acrylic, and/or combinations thereof. Preferably, the non-thermoplastic fiber material is viscose and/or modified cellulose.

The thermoplastic fiber material can be chosen among polyamide, polyester, modified polyester, polyvinyl acetate, polyethylene, polypropylene and/or combinations thereof. Preferably, the thermoplastic fiber material is polyester and/or polyamide.

The sheath of the core spun yarn may additionally comprise additives, such as flame retardant, antistatic, antimicrobial, anti-odor, mosquito-repellant additives and/or combination thereof, in amounts as known in the art.

Flame retardant additives may be chosen from brominated flame retardants, red phosphorus, asbestos, antimony trioxide, borates, metal hydrates, metal hydroxides, tetrakis (hydroxymethyl) phosphonium salts, fluorocarbons and/or combination thereof. Antistatic additives may be chosen among carbon fibers and/or metal fibers. Antimicrobial additives may be chosen among antibiotics, silver, copper, zinc and/or combinations thereof. Anti-odor and mosquito-repellant additives are known in the art.

The core spun yarns can be obtained by suitable methods known commonly in the art such as for example, but not limited to, siro-core spinning, DREF spinning, or any method that substantially covers all of the core yarns with a sheath of individual fibers. Siro-core spinning is described, for example, in WO-A 2005028722. DREF spinning is described, for example, in U.S. Pat. Nos. 4,107,909; 4,249,368; & 4,327,545.

The warp system according to the invention comprises at least one flame retardant yarn comprising aramid fibers. According to a particular weave of the fabric according to the invention, the fabric side facing the wearer comprises flame retardant fibers that confer excellent thermal protection and mechanical resistance to the fabric.

The aramid fibers of the flame retardant yarn can be meta-aramid fibers, para-aramid fibers and/or combinations thereof.

Preferably, the warp system comprises at least 30 weight %, preferably 60 to 100 weight %, more preferably 90 to 100 weight %, meta-aramid fibers, the weight % based on the total weight of the warp system.

The flame retardant yarn of the warp system can further be blended with fibers made from flame retardant cellulosic materials, e.g., flame retardant cotton, rayon, or acetate, from flame retardant wool, flame retardant polyester, polyvinyl alcohol, polytetrafluoroethylene, polyvinyl chloride (PVC), polyetheretherketone, polyetherimide, polysulfar, polychlal, polyimide, polyamide, polyimideamide, polyolefin, polybenzoxazole (PBO), polybenzimidazole (PBI), carbon, modacrylic, melamine, or other suitable flame retardant material known in the art and/or blends thereof.

The yarn of the warp system can additionally comprise also other fibers such as carbon fibers, silver fibers, silver-coated fibers, silver-loaded fibers, and/or polyamide 6.6 fibers.

The amount of such further blended and such other fibers can be in the range of 0 to 70 weight %, preferably 0.1 to 50 weight %, the weight % based on the total weight of the warp system.

The yarn of the warp system can be dyed by methods known in the art to provide a background color to the weft system.

The fabric according to the invention may have a high covering percentage of the flame retardant yarn of the warp system. That means that the flame retardant yarn of the warp system is covered by at least 70% of the weft system, preferably by 75 to 95%, more preferably by 75 to 85% of the weft system.

For example, a 80% coverage in the fabric according to the invention can also be described, for example, by the term 4/1 weave, wherein the numerator 4 indicates the number of warps that are covered by the weft yarn in the weave, and wherein the denominator 1 indicates the number of warps the weft travels under in the weave. The at least 70% coverage can correspond to, for example, 4/1 weaves and also, for example, to 5/1 weaves, 6/1 weaves, 8/2 weaves and other numbered weaves as long as the at least 70% coverage is achieved. The percentage is calculated by dividing the numerator times hundred by the sum of the denominator and numerator. For example, for a 5/1 weave, the covering percentage is 5*100/(1+5)=83.33%.

In the case of a thermal event, the fabric according to the present invention shows remarkable thermal protection properties. These outstanding thermal protection properties are caused by the special combination of materials in the fabric according to the invention. When a flame hits the weft system of the fabric according to the present invention, the combination of the at least one non-thermoplastic fiber material of the core spun yarn and the further fiber material in the fabric makes it possible to avoid a melting of fiber material. Further, in case of a combination of the at least one non-thermoplastic fiber material with thermoplastic fiber material in the core spun yarn the weft system will be less prone to ignition and also molten fiber material will not be able to soak into the warp system and contact the skin of the wearer to cause burns thereon.

The fabric according to the present invention is particularly useful for weaves used in confection of functional garments.

The weave of the fabric according to the present invention is twill and/or satin. Most preferably, the weave is satin. The weave of the fabric according to the present invention may have most of the warp system on one side of the fabric, whereas most of the weft system will be apparent on the other side of the fabric. This allows to manufacture the fabrics according to the present invention that have a ink receptive surface; that is, one side that is capable of receiving ink, while the other side or surface provides for thermal protection according to the invention. The ink receptive surface is therefore provided by the weft yarns while the thermal protection surface is provided primarily by the warp yarns.

The weave of the fabric according to the present invention is preferably reinforced with ripstop reinforcement. This can be achieved with either a ripstop weave pattern in warp and weft or with reinforcement threads that can be made of, for example, polyamide, para-aramid, polyester, polypropylene and/or combinations thereof. Ripstops can be made by dobbling the sequence of the weave, or changing the weave type from for example, 3/1 on 10 yarns to 2/2 on the next 2 yarns. This improves dramatically the tear resistance of the fabric.

When using ripstop weave patterns, the warp threads may appear on the surface of the fabric. However, since the warp threads of the fabric according to the present invention are different from the weft threads in chemical composition and therefore, colorfastness, it is preferred to replace the warp threads that may appear due to a ripstop weave pattern with weft threads. In the case where a ripstop weave pattern is used, up to 10% of the total warp threads may be replaced by warp threads made of the same material as the weft threads.

The fabric of the present invention, when used with the ink receptive surface of the woven fabric positioned as an exterior surface of the garment, can be particularly useful in combination with direct to garment printing, especially for military applications. In fact, in order to warrant maximal camouflage in a given theater, the combat uniform camouflage pattern may be specially computed on the basis on photographs taken by, for example, a UAV (Unmanned Aerial Vehicle). The computed camouflage pattern can then be printed directly onto the fabric of the present invention to manufacture theater-customized flame resistant combat uniforms offering maximal camouflage.

The fabric according to the present invention can be colored, dyed and printed with the methods known in the art. Methods include, but are not limited to, screen printing, inkjet printing, roller printing or digital textile printing, direct to garment printing and/or combinations thereof.

The present invention is further defined in the following Examples. It should be understood that these Examples are given by way of illustration only.

### EXAMPLES

### Example 1

### Preparation of a Core Spun Yarn

A high tenacity, texturized polyester core yarn having a linear mass density of 61 dtex was prepared on a ring spinning frame equipped with a positive set of rolls commonly used for elastane core spinning. A blend of fibers, containing 79% Viscose FR having a linear mass density of 2.2 dtex and 50 mm fibre length, commercially available under the name Lenzing FR, 20% polyamide 6.6 having a linear mass density of 3.3 dtex and 50 mm (fibre length) and 1% of cellulosic fibre loaded with 5% silver, commercially available under Smartcel bioactive fibre from SmartfiberAG, was prepared. The prepared fibre blend was then manufactured into two slivers of having a linear mass density of 5000 dtex (Nm 2.0). The siro core spun yarn was positively fed at a speed of 16 m/min using a yarn-drive control system. The yarn-drive control system consisted of a set of rolls driven at said speed that supported a rubber coated metallic roll. Finally, the resulting composite core-spun yarn having a texturized polyester, high tenacity filament as the core for and the prepared fibre blend for had a final yarn count of 400 dtex. (Nm 25/1).

### Example 2

### Preparation of a Fabric According to the Invention

This thus obtained composite siro core spun yarn was then used in weft in combination with a warp made of Nomex® spun yarn, commercially available under the name N324 from E. I. du Pont de Nemours & Company, consisting of 93% meta-aramid fiber having a linear mass density of 2.2 dtex, 5% para-aramid fiber having a linear mass density of 1.7 dtex and 2% antistatic carbon fiber, commercially available under the name P-140 by Invista, having a linear mass density of 3.3 dtex with a final yarn count of 200 dtex (Nm 100/2).

The fabric construction was a satin 5/1 were the warp had 41 yarns of the Nomex® spun yarn per cm and the weft had 35 yarns of composite siro core spun yarn per cm. The loom stage fabric had a surface density of 243 g/m² and a covering percentage of about 83%.

The fabric was then printed on a rotative printer using a dyeing mixture. The mixture consisted of 93.4% by weight of VAT dye and 0.6% by weight of pigment with 6% by weight acrylic binder. The print on the fabric was then thermally fixed at 150° C. in a steam chamber. The printed fabric was then further processed in an alkaline reduction step and the VAT dyes were subsequently developed in a vertical steamer operating at 105° C., followed by an acidic peroxidic oxidation step to reverse the reduction reaction. Finally, the printed fabric was washed, dried and sanforized.

### Example 3

### Test and Results

The printed fabric was then tested for breaking strength and elongation according to ISO 13934-1:1999, for tear resistance according to ISO 13937-2:2000, heat transmission on exposure to flame according to EN 367:1993, for flame spread according to ISO 15025:2000, for heat transmission on exposure to radiant heat according to ISO 6942:2002 (Method B), for heat transmission on exposure to both flame and radiant heat according to NFPA 1971 (2007 edition), clause 8.10, for pilling Martindale according to EN ISO 12945-2 2000, for abrasion Martindale according to EN ISO 12947-2 1998, for fastness to perspiration according to ISO 150 E04, for wash fastness according to ISO 150 C03 60° C. III, for light fastness according to ISO 105 B 02 *, and for air permeability according to ISO 9237.

Results are shown in Tables 1 to 9. Table 1 shows elongation at maximum force of the printed fabric according to the invention. Elongation at maximum force was 30.3% in warp direction, 22.1% in weft direction.

TABLE 1

| | Determination of elongation at maximum force |
|---|---|
| | (ISO 13934-1: 1999) |
| warp (N) | 30.3% |
| weft (N) | 22.1% |

Table 2 shows breaking strength and tear resistance of the printed fabric according to the invention. Breaking strength was 1250 N in warp direction, 1280 N in weft direction. Tear resistance was 28.5 N in warp direction, 32.5 N in weft direction.

TABLE 2

| | Determination of | |
|---|---|---|
| | breaking strength | Determination of the tear resistance |
| | (ISO 13934-1: 1999) | (ISO 13937-2: 2000) |
| warp (N) | 1250 | 28.5 |
| weft (N) | 1280 | 32.5 |

Table 3 shows heat transmission on exposure to flame of the printed fabric according to the invention. The temperature took 3.7 seconds to rise by 12 degrees Celsius, 5.7 seconds to rise by a total of 24 degrees Celsius.

TABLE 3

| | Determination of the heat transmission |
|---|---|
| | on exposure to flame |
| | (EN 367: 1993) |
| HTI 12 (s) | 3.7 |
| HTI 24 (s) | 5.7 |
| HTI 24 minus HTI 12 (s) | 2 |

Table 4 shows limited flame spread of the printed fabric according to the invention. The printed fabric according to present invention did not burn, not present any holes or form debris. Afterflame and afterglow lasted for 0 seconds.

TABLE 4

| | Determination of the limited flame spread |
|---|---|
| | (ISO 15025: 2000) |
| flame | None |
| hole | None |
| debris | None |
| afterflame (s) | 0 |
| afterglow (s) | 0 |

Table 5 shows heat transmission on exposure to radiant heat of the printed fabric according to the invention. The temperature took 7.2 seconds to rise by 12 degrees Celsius, 13.3 seconds to rise by a total of 24 degrees Celsius.

TABLE 5

| | Determination of the heat |
|---|---|
| | transmission on exposure to |
| | radiant heat |
| | (ISO 6942: 2002 Meth. B) |
| RHTI 12 (s) | 7.2 |
| RHTI 24 (s) | 13.3 |
| RHTI 24 − RHTI 12 (s) | 6.1 |

Table 6 shows the resistance to abrasion of the printed fabric according to the invention. The experiment was stopped after 100000 cycles, as no abrasion was visible.

TABLE 6
Determination of abrasion Martindale
(EN ISO 12947-2 1998)

| | |
|---|---|
| Fabric according to invention | >100.000 |
| 100% FR cotton (250-320 g/m2) | 15.000-30.000 |
| Modacrylic cotton blends (250-320 g/m2) | 30.000-50.000 |

Table 7 shows the heat transmission on exposure to both flame and radiant heat of the printed fabric according to the invention. The time to record pain is 5 seconds and the time to 2^{nd} degree burns is 6 seconds. The heat flux was 11.9 calories per centimeter square.

TABLE 7

| | Determination of heat |
|---|---|
| | transmission on exposure to both |
| | flame and radiant heat |
| | (NFPA 1971 (2007 edition), clause |
| | 8.10) |
| time to record pain (s) | 5 |
| time to 2nd degree burn (s) | 6 |
| TPP (cal/cm2) | 11.9 |

Table 8 shows the lightfastness of the printed fabric according to the invention a scale of 0 to 8, with 8 being the top rating, 0 being the worst rating. The fabric according to the invention has a lightfastness of 6 to 7.

TABLE 8
Determination of the lightfastness
(ISO 105 B 02)
6 to 7

Table 9 shows the air permeability of the printed fabric according to the invention, shown in liters per square meter per second. Air permeability of the printed fabric according to the invention is 34.6.

TABLE 9
Determination of air permeability
(ISO 9237)
34.6 l/m2 * s

As the results above show, the fabric according to the present invention complies to the heat and flame requirements of EN 531 or ISO 11612 at levels A, B1, C1. Level A represents a pass of the limited flame spread test according to ISO 15025:2000, procedure A. Level B1 represents a pass of the heat transmission on exposure to flame test according to EN 367. Level C1 represents a pass of the heat transmission on exposure to radiant heat test according to ISO 6942:2002, Method B.

Furthermore, the results shown in Table 8 are showing that the light fastness confirming that this fabric is good for use as a camouflage printed military uniform, as the rating 6 to 7 is near the top rating of 8.

The good mechanical performances and abrasion resistance are meeting the requirements for combat uniforms, and show that the fabric according to the present invention presents a good resistance to abrasion when compared to other textiles. Finally, the good air permeability and the soft handle offer a good wearing comfort to the wearer.

The above experiments show that the fabric according to the present invention provides effective protection against heat and flame, while at the same time showing good abrasion properties.

What is claimed is:

1. A fabric comprising:
a. a warp system comprising yarns, including at least one flame retardant yarn comprising meta-aramid fibers, para-aramid fibers and/or combinations thereof, and
b. a weft system comprising yarns, including at least one core spun yarn
wherein the fabric has a satin or twill weave and the flame retardant yarn of the warp system is covered by at least 70% by the yarns of the weft system.

2. The fabric according to claim 1, wherein the weft system provides an ink receptive surface.

3. The fabric according to claim 1, wherein the warp system comprises at least 30 weight % meta-aramid fibers, the weight % based on the total weight of the warp system.

4. The fabric according to claim 1, wherein the core-spun yarn has a core and a sheath and the core is poly(phenylene sulfide sulfone), aramid, acrylic, elastane, polypropylene, polyethylene, polyester and/or combinations thereof and the sheath comprises at least one non-thermoplastic fiber material.

5. The fabric according to claim 4, wherein the core comprises polyester fibers, elastane fibers and/or combinations thereof.

6. The fabric according to claim 4, wherein the at least one non-thermoplastic fiber material is chosen among cellulose, viscose, modified cellulose, modacrylic, acrylic, and/or combinations thereof.

7. The fabric according to claim 1 further provided with ripstop reinforcement.

8. A protective garment comprising the woven fabric of claim 1.

9. A protective garment comprising the woven fabric of claim 2.

10. The protective garment of claim 9 wherein the ink receptive surface of the woven fabric is an exterior surface of the garment.

11. The protective garment of claim 10 provided with camouflage printing.
